(19) United States
(12) Patent Application Publication
(10) Pub. No.: US 2009/0297242 A1
(43) Pub. Date: Dec. 3, 2009

(54) IMAGE FORMING APPARATUS

(75) Inventor: Yoshiharu Kanematsu, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/475,630

(22) Filed: Jun. 1, 2009

(30) Foreign Application Priority Data
May 30, 2008 (JP) 2008-143785

(51) Int. Cl. G03G 15/00

(52) U.S. Cl. 399/400

(57) ABSTRACT

An image forming apparatus includes an image transfer portion for transferring a toner image to a printing sheet. A fixing portion includes a fixing member and a pressure member pressed against the fixing member for fixing the toner image to the printing sheet. A guide is between the image transfer portion and the fixing portion for guiding the printing sheet carrying the toner image toward a nip between the fixing member and the pressure member. The guide includes a rigid first guide plate and a flexible second guide plate joined to the first guide plate at a downstream portion thereof along a sheet feeding direction. The second guide plate has a free downstream end that is closer to the fixing member than a tangent line drawn to pass through the nip between the fixing member and the pressure member.

### BACKGROUND OF THE INVENTION

1. Field of the Invention

The present invention relates to an image forming apparatus provided with a fixing device for fixing a toner image formed on a printing sheet by performing image forming operation.

2. Description of the Related Art

Generally, an image forming apparatus comprises an image transfer portion for transferring a toner image to a printing sheet and a fixing device for fixing the toner image to the printing sheet to which the toner image has been transferred. A commonly known fixing device includes a fixing roller having a built-in heat source and a pressure roller whose outer peripheral surface is pressed against an outer peripheral surface of the fixing roller. The printing sheet carrying the toner image transferred thereto is sent to a nipping part formed between the fixing roller and the pressure roller. As heat is applied to the printing sheet at this nipping part, the toner image is fixed to the printing sheet.

There is provided a guide member between the fixing roller and the pressure roller for guiding the printing sheet being transported. Japanese Unexamined Patent Publication No. 2003-345154 describes a structure in which a guide member made of an elastic material is adhered in such a manner that the guide member mitigates an impact produced when a leading edge of a curled printing sheet hits against an upper surface of the guide member. This structure however causes the leading edge of the printing sheet to hit against the elastic guide member and, as a result, a surface of the printing sheet rubs the surface of the guide member. This structure potentially causes a problem that repeated rubbing of the elastic guide member by the leading edge of the printing sheet can lead to wearing of the guide member and eventual breakage thereof.

### SUMMARY OF THE INVENTION

Accordingly, it is an object of the invention to provide an image forming apparatus configured to properly guide a printing sheet toward a fixing portion.

To achieve the aforementioned object, an image forming apparatus according to one feature of the invention comprises an image transfer portion for transferring a toner image to a printing sheet, a fixing portion including a fixing member and a pressure member pressed against the fixing member for fixing the toner image to the printing sheet to which the toner image has been transferred, and a guide member disposed between the image transfer portion and the fixing portion for guiding the printing sheet carrying the toner image transferred thereto toward a nipping part formed between the fixing member and the pressure member. The guide member includes a first guide plate having rigidity, and a second guide plate having flexibility which is joined to the first guide plate at a downstream portion thereof along a sheet feeding direction, the second guide plate having a downstream end constituting a free end. The downstream end of the second guide plate is located at a position closer to the fixing member than a tangent line drawn to pass through the nipping part between the fixing member and the pressure member.

According to another feature of the invention, an image forming apparatus configured to form an image on either of a first type of printing sheet having a first flexure strength and a second type of printing sheet having a second flexure strength comprises an image transfer portion for transferring a toner image to the printing sheet, a fixing portion including a fixing member and a pressure member pressed against the fixing member, forming a nipping part in between, for fixing the toner image to the printing sheet to which the toner image has been transferred, a sheet transporting path for guiding the printing sheet from the image transfer portion to the fixing portion, and a flexible guide plate disposed against the fixing member at a downstream position of the sheet transporting path, the flexible guide plate having a downstream end constituting a free end. The downstream end of the flexible guide plate is located at a position closer to the fixing member than a tangent line drawn to pass through the nipping part between the fixing member and the pressure member. The flexible guide plate does not substantially warp when guiding the first type of printing sheet but substantially warps when guiding the second type of printing sheet.

These and other objects, features and advantages of the invention will become more apparent upon reading the following detailed description along with the accompanying drawings.

### BRIEF DESCRIPTION OF THE DRAWINGS

FIG. 1 is a cross-sectional diagram generally showing the structure a printer according to the present invention;

FIG. 2 is a perspective diagram showing, in particular, a guide member according to a first embodiment of the invention;

FIG. 3 is a cross-sectional diagram taken along lines III-III of FIG. 2;

FIGS. 4A, 4B and 4C are cross-sectional diagrams showing how the guide member works when a printing sheet fed into a fixing portion of the printer is ordinary paper;

FIGS. 5A, 5B and 5C are cross-sectional diagrams showing how the guide member works when a printing sheet fed into the fixing portion is thick paper; and

FIG. 6 is a cross-sectional diagram for explaining, in particular, a guide member according to a second embodiment of the invention.

### DETAILED DESCRIPTION OF THE PREFERRED EMBODIMENTS

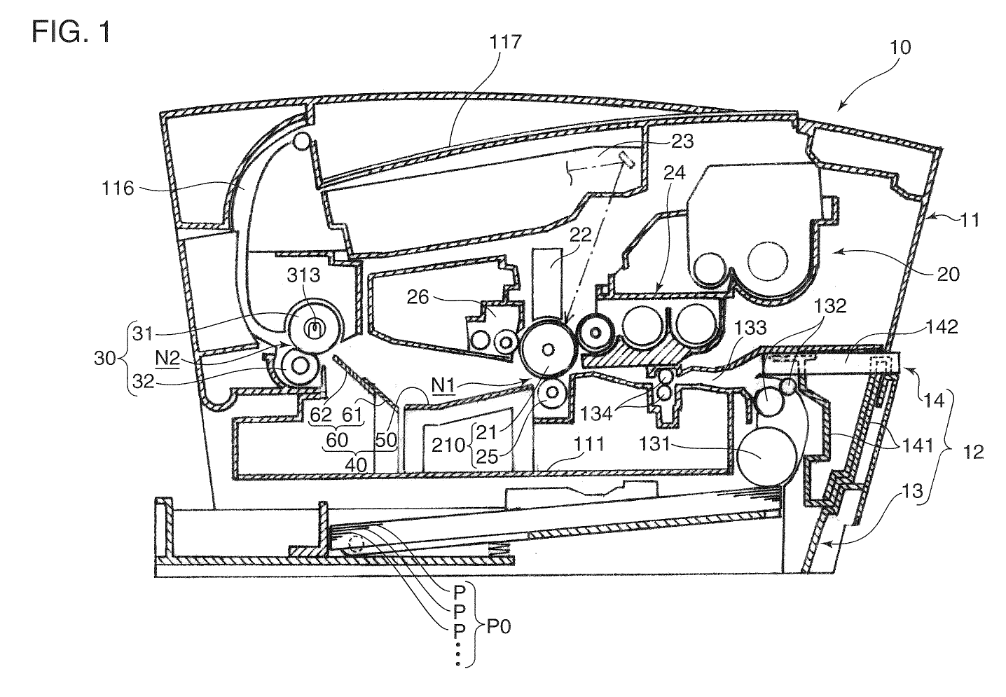

FIG. 1 is a cross-sectional diagram generally showing the structure of a printer 10 according to the present invention. The printer 10 includes a main apparatus body 11 incorporating a sheet feeding portion 12, an image forming unit 20 (having an image transfer portion 210) and a fixing portion 30. The sheet feeding portion 12 stores a stack P0 of printing sheets P used for print job. The printing sheets P are fed one after another from the stack P0 held in the sheet feeding portion 12, or each printing sheet P is manually fed from a below-described manual feeder 14. The image forming unit 20 performs image transfer operation for transferring a toner image to the printing sheet P fed from the sheet feeding portion 12 and the fixing portion 30 performs image fixing operation for fixing the toner image to the printing sheet P which has gone through the image transfer operation performed by the image forming unit 20. The printing sheet P carrying the toner image to which the toner image has been fixed by the fixing portion 30 is ejected onto an output tray 117 provided at the top of the main apparatus body 11.

The sheet feeding portion 12 includes a paper cassette 13 for holding the stack P0 of the printing sheets P, the paper cassette 13 being removable from and insertable into the main apparatus body 11, and the aforementioned manual feeder 14 located above the paper cassette 13. Also provided in the main apparatus body 11 are a large-diameter pickup roller 131 located above an output end of the paper cassette 13 (located at a right end as illustrated in FIG. 1) for picking up and feeding one printing sheet P after another from the stack P0 in the paper cassette 13 and a pair of small-diameter transport rollers 132 located immediately above the pickup roller 131.

When driven to rotate, the pickup roller 131 picks up and feeds an uppermost one of the printing sheets P. Then, the printing sheet P is advanced by the pair of transport rollers 132 and through a paper path 133 to a pair of registration rollers 134 located at a downstream end of the paper path 133, from where the printing sheet P is fed into the image forming unit 20.

The manual feeder 14 includes a tray support member 141 of which rear end is located at an upstream end of the image forming unit 20 and a manual feed tray 142 supported by the tray support member 141. The printing sheet P inserted into the manual feed tray 142 is advanced to an image transfer nipping part N1 formed at a position where an outer peripheral surface of a photosensitive drum 21 and an outer peripheral surface of an image transfer roller 25 are placed face to face with each other when the pair of registration rollers 134 is driven to rotate.

The image forming unit 20 performs the image transfer operation for transferring the toner image to the printing sheet P according to image information fed from a computer, for example. The image forming unit 20 includes the aforementioned photosensitive drum 21 which is mounted ratably about a drum axis extending in a direction perpendicular to the plane of the page of FIG. 1, a charging unit 22, part of which is disposed along the outer peripheral surface of the photosensitive drum 21 from a position immediately above the photosensitive drum 21 in a clockwise direction (as illustrated in FIG. 1), an exposure unit 23, a developing unit 24, the aforementioned image transfer roller 25 and a cleaning unit 26. The photosensitive drum 21 and the image transfer roller 25 together constitute the aforementioned image transfer portion 210.

The photosensitive drum 21 forms an electrostatic latent image on the outer peripheral surface and this electrostatic latent image is developed into the toner image. Amorphous silicon is deposited on the outer peripheral surface of the photosensitive drum 21 to form a layer having an extremely smooth finish with excellent rigidity. The photosensitive drum 21 having this amorphous silicon layer is suited for forming the electrostatic latent image and the toner image.

As the photosensitive drum 21 rotates in the clockwise direction (as illustrated in FIG. 1) about the drum axis, the charging unit 22 uniformly charges the outer peripheral surface of the photosensitive drum 21. The charging unit 22 of this printer 10 is of a corona discharge type in which a corona discharge from a wire electrically charges the outer peripheral surface of the photosensitive drum 21. Alternatively, the charging unit 22 may be of a charging roller type in which a charging roller which is a driven roller held in contact with the photosensitive drum 21 applies electric charge to the outer peripheral surface of the photosensitive drum 21 while rotating.

The exposure unit 23 emits a beam of laser light of which intensity is varied according to image data fed from an external apparatus like a computer on the outer peripheral surface of the rotating photosensitive drum 21. The electrostatic latent image is formed on the outer peripheral surface of the photosensitive drum 21 as part of the electric charge applied thereto is erased in areas where the laser light is emitted.

The developing unit 24 supplies toner contained in developer to the outer peripheral surface of the photosensitive drum 21 to adhere toner particles on the electrostatic latent image, thereby the toner image is formed on the outer peripheral surface of the photosensitive drum 21. The image transfer roller 25 transfers the positively charged toner image formed on the outer peripheral surface of the photosensitive drum 21 to the printing sheet P which has been fed to a position immediately below the photosensitive drum 21. For executing this image transfer operation, the image transfer roller 25 applies a negative charge to the printing sheet P. Thus, the outer peripheral surface of the image transfer roller 25 is charged to polarity opposite to the polarity of the charge applied to the printing sheet P. As the printing sheet P which is passed through the image transfer portion 210 is nipped under pressure between the image transfer roller 25 and the photosensitive drum 21, the image transfer portion 210 performs the image transfer operation in which the toner image on the positively charged outer peripheral surface of the photosensitive drum 21 is peeled off and attracted toward a facing surface of the negatively charged printing sheet P.

The cleaning unit 26 cleans the outer peripheral surface of the photosensitive drum 21 by removing toner particles (residual toner) remaining thereon upon completion of the image transfer operation. As the photosensitive drum 21 rotates, part of the outer peripheral surface thereof cleaned by the cleaning unit 26 moves toward the charging unit 22 in preparation of a succeeding image forming task.

The fixing portion 30 performs the image fixing operation in which the printing sheet P carrying the toner image transferred thereto in the image forming unit 20 is heated. The fixing portion 30 includes a fixing roller (fixing member) 31 provided with built-in electric heating elements 313 and a pressure roller 32 (pressure member) located below the fixing roller 31 with outer peripheral surfaces of the fixing roller 31 and the pressure roller 32 disposed face to face with each other.

As the printing sheet P carrying the toner image transferred thereto is passed through a fixing nipping part N2 formed between the fixing roller 31 which is driven to rotate in the clockwise direction about a longitudinal axis and the pressure roller 32 which is a driven roller driven to rotate in a counterclockwise direction about a longitudinal axis (as illustrated in FIG. 1), the fixing roller 31 applies heat to the printing sheet P to execute the image fixing operation. Then, the printing sheet P carrying the toner image fixed thereto is ejected onto the output tray 117 through a sheet output path 116.

The above-described printer 10 of the invention is provided with a sheet guiding mechanism 40 for guiding the printing sheet P carrying the toner image transferred thereto further downstream. The sheet guiding mechanism 40 is located between the image transfer nipping part N1 formed between the photosensitive drum 21 and the image transfer roller 25 and the fixing nipping part N2 formed between the fixing roller 31 and the pressure roller 32 of the fixing portion 30.

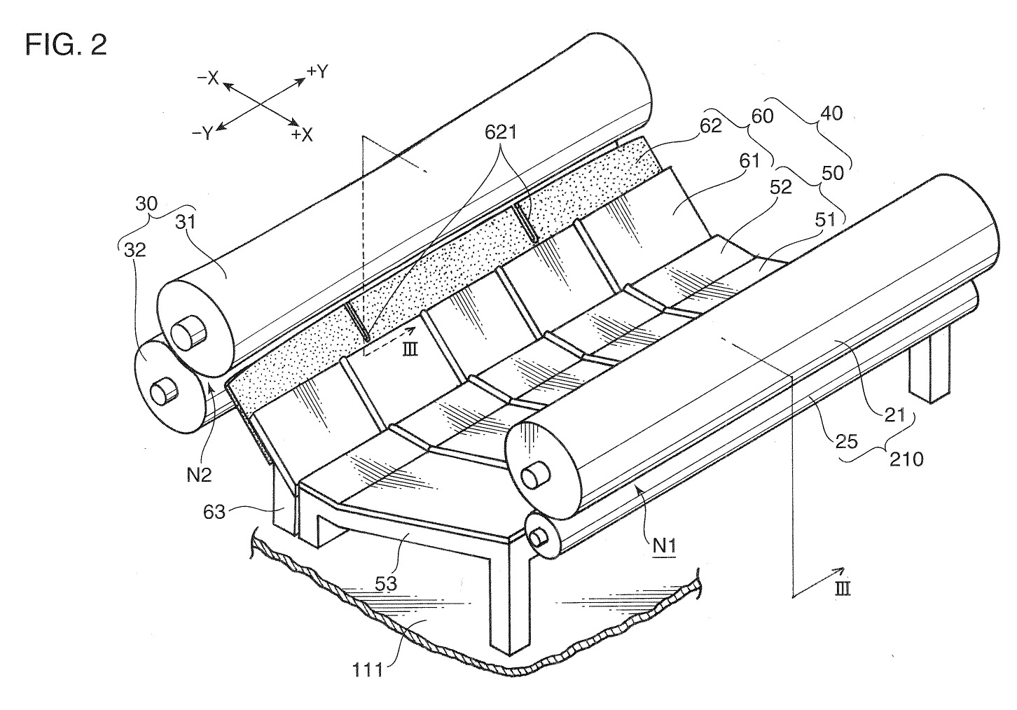

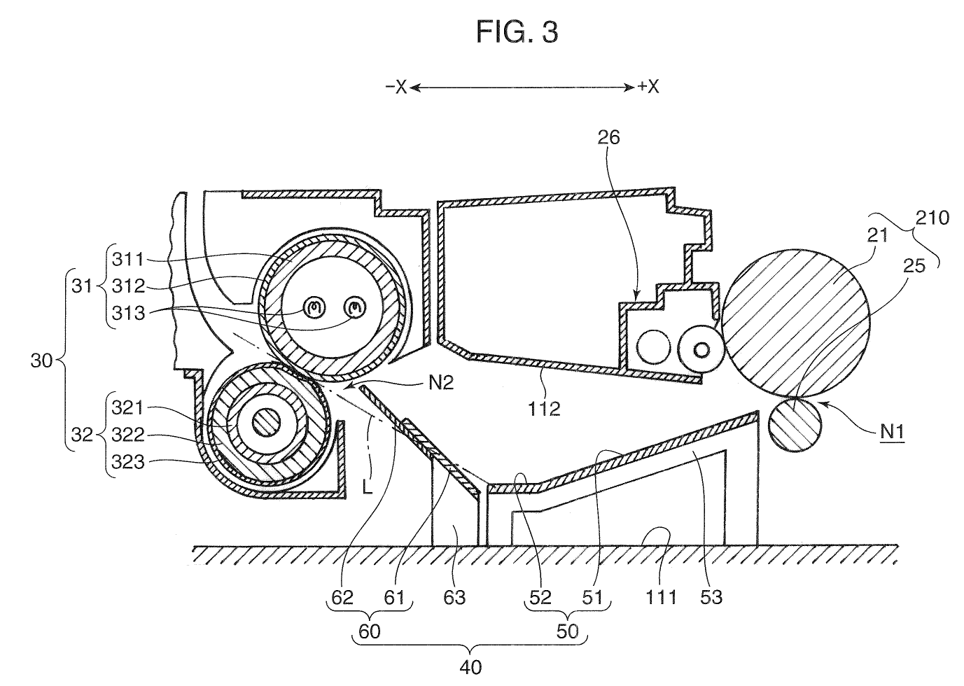

FIG. 2 is a perspective diagram showing, in particular, the sheet guiding mechanism 40 provided with a guide member 60 according to a first embodiment of the invention, and FIG. 3 is a cross-sectional diagram taken along lines III-III of FIG. 2. FIG. 3 shows not only the fixing portion 30 and the sheet guiding mechanism 40 but also components provided therearound as much as possible. As depicted in FIGS. 2 and 3, the symbols −X/+X represent a left-right direction and the symbols −Y/+Y represent a front-rear direction. In particular, −X denotes a leftward direction, +X denotes a rightward direction, −Y denotes a frontward direction and +Y denotes a rearward direction.

The fixing portion 30 includes the fixing roller 31 which is elongate along the front-rear direction and the pressure roller 32 which is elongate along the front-rear direction and located below the fixing roller 31 face to face therewith, the fixing roller 31 and the pressure roller 32 being mounted in an unillustrated housing of the fixing portion 30.

The fixing roller 31 has a so-called inverted crown shape in which the outside diameter of the fixing roller 31 gradually decreases from both ends toward a middle portion thereof. The fixing roller 31 has a cylindrical body 311 rotatably supported by the housing of the fixing portion 30 and a fluoroplastic layer 312 deposited on an outer peripheral surface of the cylindrical body 311. The cylindrical body 311 is a cylinder made of aluminum or iron, for example. The fluoroplastic layer 312 is formed by coating the outer peripheral surface of the cylindrical body 311 with polytetrafluoroethylene (PTFE), perfluoroalkoxy (PFA) or the like, the fluoroplastic layer 312 having a thickness of 30 micrometers, for example. As an alternative, the fluoroplastic layer 312 may be made by fitting a fluoroplastic tube on the cylindrical body 311 instead of using the aforementioned coating process.

The cylindrical body 311 incorporates the aforementioned electric heating elements 313 which may be halogen lamps, for example. When electrified, the electric heating elements 313 produce heat which is imparted to the fixing roller 31 and transmitted to the printing sheet P fed to the fixing nipping part N2.

The pressure roller 32 is mounted below the fixing roller 31 in such a manner that the longitudinal axis (rotary axis) of the pressure roller 32 is located at a position slightly to the left of the longitudinal axis (rotary axis) of the fixing roller 31 and the fixing roller 31 and the pressure roller 32 press against each other with the outer peripheral surfaces thereof in direct contact.

The pressure roller 32 has a main pressure roller body 321 which is a cylindrical body made of an aluminum alloy or plated iron, an elastic cylindrical body 322 made of silicone rubber integrally fitted on the main pressure roller body 321 on a common axis therewith and a fluoroplastic layer 323 made of PFA coated on an outer peripheral surface of the elastic cylindrical body 322. The fixing nipping part N2 is formed between the fluoroplastic layers 312, 323 of the fixing roller 31 and the pressure roller 32 which are normally held in direct contact with each other.

The pressure roller 32 is not formed into a crown shape in which the outside diameter of the pressure roller 32 gradually increases from both ends toward a middle portion thereof so that the shape of the outer peripheral surface of the pressure roller 32 fits the inverted crown shape of the outer peripheral surface of the fixing roller 31. Rather, the pressure roller 32 has the same outside diameter all along the length thereof. The pressure roller 32 is so structured because the pressure roller 32 having the elastic cylindrical body 322 can deform due to compressive elastic deformation of the elastic cylindrical body 322 to fit the inverted crown shape of the outer peripheral surface of the fixing roller 31.

The fixing portion 30 is provided with a driving motor (not shown) mounted at an appropriate position of the housing of the fixing portion 30. A driving force generated by this driving motor is transmitted to the fixing roller 31 through a reduction mechanism (not shown), thereby causing the fixing roller 31 to rotate about the axis thereof. This rotary motion of the fixing roller 31 is transmitted to the pressure roller 32 which is held in contact with the fixing roller 31 under pressure. As a result, the fixing roller 31 and the pressure roller 32 rotate in opposition directions and feed the printing sheet P leftward (as illustrated in FIG. 3) while heating the printing sheet P to perform the image fixing operation.

The sheet guiding mechanism 40 serves to form a sheet transporting path along which the printing sheet P is guided from the image transfer nipping part N1 to the fixing nipping part N2, the sheet guiding mechanism 40 including an upstream guide plate 50 for guiding the printing sheet P output from the image transfer nipping part N1 by a specific distance downstream and a guide member 60 disposed between a downstream end of the upstream guide plate 50 and the fixing nipping part N2.

The upstream guide plate 50 has a slanting portion 51 sloping leftwardly downward (downstream along a sheet feeding direction) from the image transfer nipping part N1 and a horizontal portion 52 extending slightly leftward in a horizontal plane from a downstream end of the slanting portion 51 as depicted in FIG. 3. The horizontal portion 52 is located at a position slightly lower than the fixing nipping part N2. The upstream guide plate 50 is mounted on a supporting base 53 provided on a partitioning frame 111 which is located in the main apparatus body 11 immediately above the paper cassette 13.

The guide member 60 includes a rigid guide plate (first guide plate) 61 provided immediately downstream of the horizontal portion 52 of the upstream guide plate 50 and a flexible guide plate (second guide plate) 62 disposed to extend from a left end part of a bottom surface of the rigid guide plate 61. The flexible guide plate 62 has a downstream end constituting a free end.

While the rigid guide plate 61 is made of metal or hard synthetic resin, the flexible guide plate 62 is made of a film of synthetic resin having flexibility. When the printing sheet P carrying the toner image transferred thereto reaches the flexible guide plate 62, the flexible guide plate 62 warps if the printing sheet P is a thick sheet of paper (second type of printing sheet). This is because this type of printing sheet P exerts a pushing force on the flexible guide plate 62. The flexible guide plate 62 does not warp due to the pushing force exerted by the printing sheet P if the printing sheet P which has reached the flexible guide plate 62 is an ordinary sheet of paper (e.g., copying paper, or first type of printing sheet). The flexibility (elasticity) of the flexible guide plate 62 is determined such that the flexible guide plate 62 does not warp if the printing sheet P is an ordinary sheet of paper but warps if the printing sheet P is a thick sheet of paper. In other words, the flexible guide plate 62 does not warp if the printing sheet P passed over the flexible guide plate 62 has a flexure strength (first flexure strength) equal to or less than a specific value, and the flexible guide plate 62 warps if the printing sheet P passed over the flexible guide plate 62 has a flexure strength (second flexure strength) exceeding the specific value.

While the embodiment discussed herein is an example in which each ordinary sheet of paper has the first flexure strength and each thick sheet of paper has the second flexure strength which is greater than the first flexure strength, the flexure strength of the printing sheet P does not depend simply on the thickness thereof. Even if the printing sheet P has substantially the same thickness as the ordinary sheet of paper, the printing sheet P may have the second flexure strength depending on a raw material of the printing sheet P, properties of the printing sheet P, or whether the printing sheet P has a particular surface coating, for instance.

An upstream end of the rigid guide plate 61 is located at a position slightly lower than the horizontal portion 52 of the upstream guide plate 50 and a downstream end portion of the rigid guide plate 61 slopes leftwardly upward (as illustrated) so that the rigid guide plate 61 is oriented in a direction toward a point slightly above the fixing nipping part N2. Approximately right half of the rigid guide plate 61 is fixed to a supporting base 63 so that approximately left half of the rigid guide plate 61 projects from the supporting base 63 as if overhanging therefrom. The flexible guide plate 62 is supported by the rigid guide plate 61 with an upstream portion of the flexible guide plate 62 adhered to or screwed to this overhanging portion of the rigid guide plate 61 on the bottom surface thereof.

The guide member 60 is fixedly mounted on the supporting base 63 at an angle of inclination which is slightly larger than an angle of inclination of a tangent line L drawn rightwardly downward from the fixing nipping part N2 with respect to the horizontal plane as depicted in FIG. 3. A downstream end of the guide member 60 (i.e., a downstream end of the flexible guide plate 62) is located above the aforementioned tangent line L at a position closer to the fixing roller 31. Therefore, the printing sheet P guided by the guide member 60 hits against the outer peripheral surface of the fixing roller 31 at a position located above the fixing nipping part N2 under conditions where the flexible guide plate 62 is not warped.

As shown in FIG. 2, the flexible guide plate 62 has a pair of slits 621 formed therein by cutting the flexible guide plate 62 from a left end thereof at positions separated symmetrically from a mid-length position of the flexible guide plate 62 by the same distance in opposition directions along the front-rear direction. The distance between the two slits 621 is made slightly larger the width of the printing sheet P having a large thickness (e.g., a post card) which may be passed through the fixing portion 30. Therefore, if the printing sheet P passed through the image transfer nipping part N1 is a sheet having a large thickness (hereinafter referred to as a thick sheet of paper P2 or, simply, thick paper P2), this thick paper P2 passes between the two slits 621 formed in the flexible guide plate 62 after arriving at the flexible guide plate 62 by way of the upstream guide plate 50 and the rigid guide plate 61. In this case, only a middle portion of the flexible guide plate 62 between the two slits 621 warps due to the weight of the thick paper P2.

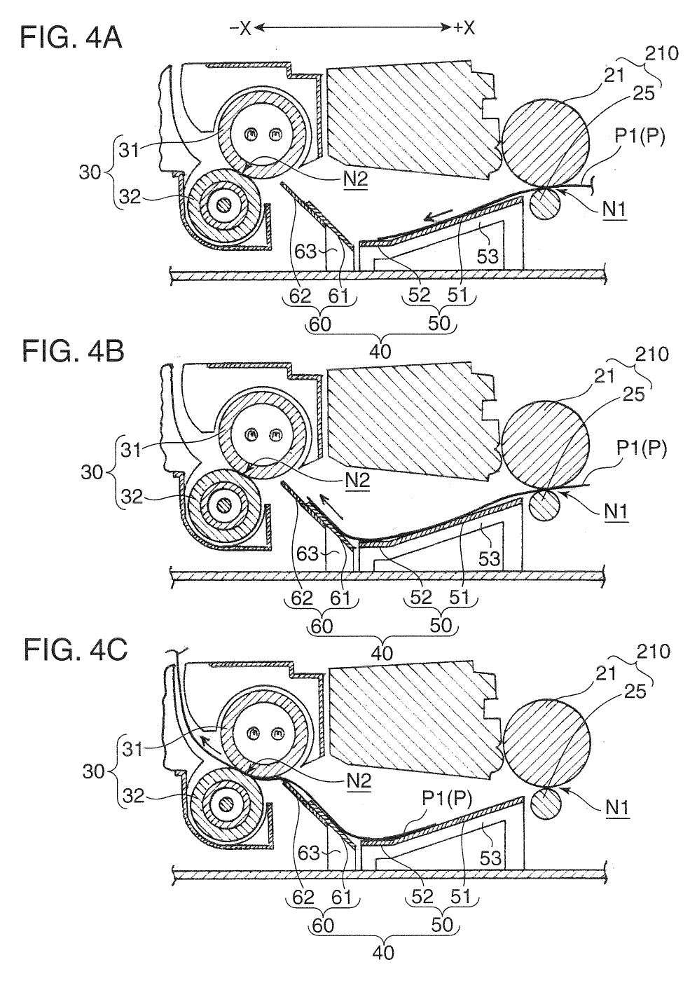

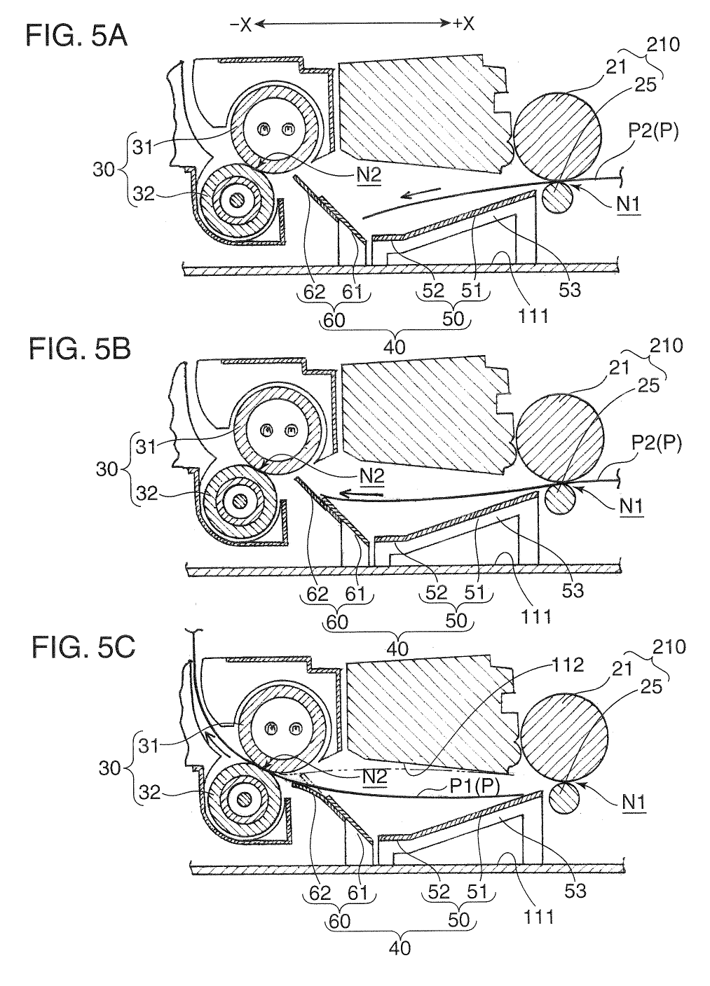

The working of the guide member 60 of the first embodiment is now described with reference to FIGS. 4A-4C and 5A-5C which are cross-sectional diagrams showing how the guide member 60 of the first embodiment works. Specifically, FIGS. 4A-4C show a case where the printing sheet P fed into the fixing portion 30 is an ordinary sheet of paper P1 (simply, ordinary paper P1), and FIGS. 5A-5C show a case where the printing sheet P fed into the fixing portion 30 is a thick sheet of paper P2. In these Figures, FIGS. 4A and 5A show a state in which the printing sheet P passed through the image transfer nipping part N1 is being transported over the sheet guiding mechanism 40, FIGS. 4B and 5B show a state in which a leading edge of the printing sheet P has reached the guide member 60, and FIGS. 4C and 5C show a state in which the toner image is being fixed to the printing sheet P at the fixing nipping part N2. In FIGS. 4A-4C and 5A-5C, the symbols −X/+X represent the left-right direction, −X denoting the leftward direction and +X denoting the rightward direction, as previously mentioned with reference to FIG. 3.

First, the working of the guide member 60 is explained using an example shown in FIGS. 4A-4C in which the printing sheet P is the ordinary paper P1. Since the ordinary paper P1 is generally not so stiff as the thick paper P2, a portion of the ordinary paper P1 close to the leading edge thereof forms a floating end which can droop extremely easily by its own weight. Thus, when the ordinary paper P1 is passed through the image transfer nipping part N1, the floating end (leading edge portion) of the ordinary paper P1 slides down along the slanting portion 51 of the upstream guide plate 50 and moves toward the guide member 60 as shown in FIG. 4A.

The ordinary paper P1 whose leading edge has arrived at the guide member 60 is transported further downstream toward the fixing nipping part N2 between the fixing roller 31 and the pressure roller 32 along an upward sloping surface of the guide member 60 in face-to-face contact with an upper surface of the rigid guide plate 61 as shown in FIG. 4B. Subsequently, the leading edge of the ordinary paper P1 is advanced further onto the flexible guide plate 62.

Since the flexible guide plate 62 has a flexure strength higher than that of the ordinary paper P1, the flexible guide plate 62 does not warp even if the ordinary paper P1 passes over the flexible guide plate 62. Thus, the leading edge of the ordinary paper P1 hits against the outer peripheral surface of the fixing roller 31. Subsequently, as the leading edge of the ordinary paper P1 is guided by the fixing roller 31 rotating in the clockwise direction, the ordinary paper P1 is advanced toward the fixing nipping part N2 as shown in FIG. 4C. The toner image is fixed to the ordinary paper P1 at the fixing nipping part N2 as the fixing roller 31 imparts heat to the ordinary paper P1.

Immediately before passing through the fixing nipping part N2, the ordinary paper P1 is in a state in which the leading edge thereof is positioned in contact with or close to the outer peripheral surface of the fixing roller 31 between part of the outer peripheral surface of the fixing roller 31 to which the downstream end of the flexible guide plate 62 is directed and the fixing nipping part N2. The ordinary paper P1 is preheated in this state. Fine particles of the toner on the ordinary paper P1 soften to a certain extent as a result of such preheating and adjacent toner particles become attached to one another. If the ordinary paper P1 is not preheated in this manner, the toner is rapidly heated when the ordinary paper P1 goes through the image transfer nipping part N1 and, as a result, the rapidly heated toner produces a high-pressure gas which causes the toner particles to blow out in an upstream direction and contaminate the printing sheet P, causing a so-called smearing phenomenon. Preheating of the ordinary paper P1 serves to prevent this problem.

Next, the working of the guide member 60 is explained using an example shown in FIGS. 5A-5C in which the printing sheet P is the thick paper P2 having a high flexure strength. Immediately after the thick paper P2 has been transported onto the sheet guiding mechanism 40 through the image transfer nipping part N1, a floating end (leading edge portion) of the thick paper P2 does not droop due to stiffness thereof as shown in FIG. 5A. At this point, the leading edge of the thick paper P2 is directed almost straight toward the rigid guide plate 61 of the guide member 60 without sliding along an upper surface of the upstream guide plate 50.

Then, the thick paper P2 whose leading edge has arrived at the rigid guide plate 61 of the guide member 60 is transported further toward the flexible guide plate 62 thereof with the leading edge of the thick paper P2 guided along an upward sloping surface of the rigid guide plate 61 as shown in FIG. 5B.

The flexure strength of the flexible guide plate 62 is lower than that of the thick paper P2, so that the flexible guide plate 62 warps when the thick paper P2 lies on the flexible guide plate 62. Specifically, the thick paper P2 being transported over the flexible guide plate 62 does not warp but presses against the flexible guide plate 62, causing a left end portion of the flexible guide plate 62 to warp downward as shown in FIG. 5C.

As the thick paper P2 causes the flexible guide plate 62 to warp in this fashion, it is possible to prevent a trailing edge portion (right end portion as illustrated) of the thick paper P2 which has passed through the image transfer nipping part N1 from going into contact with a top plate 112 provided between the image transfer portion 210 and the fixing roller 31. If the guide member 60 is configured to include a rigid plate instead of the flexible guide plate 62, the thick paper P2 which has arrived at a downstream end of this rigid plate will warp in an upwardly bulging arc-shaped form as seen from a direction perpendicular to the sheet feeding direction as shown by an alternate long and two short dashed line in FIG. 5C. When the thick paper P2 thus warped is advanced downstream completely through the image transfer nipping part N1, the trailing edge portion of the thick paper P2 flips upward against the top plate 112 and, as a result of an impact produced at this time, toner particles previously left adhering to the top plate 112 would adhere to the trailing edge portion of the thick paper P2, contaminating the toner image transferred thereto. The above-described structure of the present embodiment does not cause this kind of inconvenience.

Generally, the thick paper P2 is transported at a speed lower than the ordinary paper P1. Therefore, the aforementioned smearing phenomenon does not occur with the thick paper P2 even if the thick paper P2 is not preheated before the same arrives at the fixing nipping part N2.

The flexible guide plate 62 of the guide member 60 is attached to the bottom surface of the rigid guide plate 61 which is provided upstream of the flexible guide plate 62. Thus, after the leading edge of the printing sheet P hits against the rigid guide plate 61, the printing sheet P fed through the image transfer nipping part N1 slides upward along the rigid guide plate 61 toward the flexible guide plate 62 which is located a slight step below (FIGS. 4B and 5B). Since the leading edge of the printing sheet P does not hit directly against the flexible guide plate 62 in this structure of the embodiment, the flexible guide plate 62 is kept from being damaged.

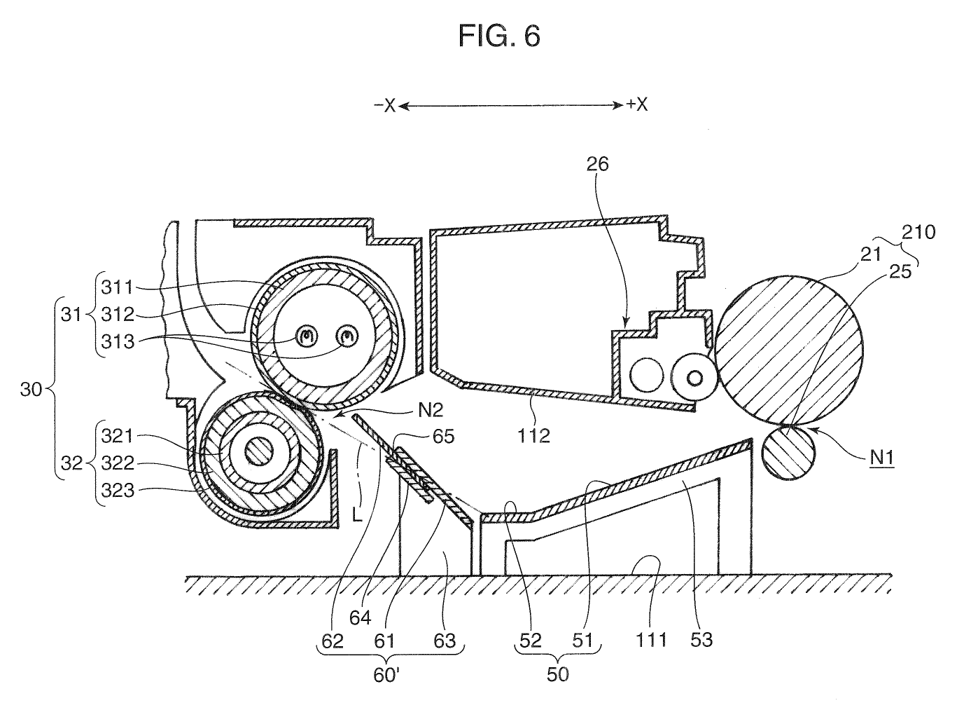

FIG. 6 is a cross-sectional diagram for explaining, in particular, a guide member 60′ according to a second embodiment of the invention, in which the symbols −X/+X represent the left-right direction, −X denoting the leftward direction and +X denoting the rightward direction, as previously mentioned with reference to FIG. 3.

The guide member 60′ of the second embodiment includes a slanting backplate (a part of supporting member) 64 for supporting a flexible guide plate 62. This slanting backplate 64 is mounted on an upper left portion of a supporting base 63 parallel to and beneath a rigid guide plate 61. There is formed a mounting groove 65 between the slanting backplate 64 and the rigid guide plate 61 so that the slanting backplate 64 can be fitted in the mounting groove 65. The guide member 60′ has otherwise the same structure as the guide member 60 of the above-described first embodiment.

The guide member 60′ thus structured makes it possible to attach the flexible guide plate 62 to the rigid guide plate 61 by simply fitting the flexible guide plate 62 in the mounting groove 65, thus providing enhanced ease of assembly of the flexible guide plate 62.

As thus far described in detail in the foregoing embodiments, the printer 10 is so configured that the toner image is transferred to the printing sheet P as the printing sheet P passes through the image transfer nipping part N1 and fixed to the printing sheet P as the printing sheet P passes through the fixing nipping part N2. The guide member 60 (60′) for guiding the printing sheet P is located between the image transfer nipping part N1 and the fixing nipping part N2.

The guide member 60 of the first embodiment includes the flexible guide plate 62 of which downstream end is located closer to the fixing roller 31 than the tangent line L of the fixing roller 31 drawn from the fixing nipping part N2 as well as the rigid guide plate 61 located upstream of the flexible guide plate 62. After the image transfer operation, the printing sheet P is transported to slide along the rigid guide plate 61 and along the flexible guide plate 62, and then guided toward the fixing nipping part N2. The flexibility (elasticity) of the flexible guide plate 62 is determined such that the flexible guide plate 62 does not warp when an ordinary sheet of paper P1 passes over the flexible guide plate 62 while the flexible guide plate 62 warps when a thick sheet of paper P2 like a post card passes over the flexible guide plate 62.

Accordingly, the flexible guide plate 62 does not warp when the ordinary paper P1 passes over the flexible guide plate 62 and, for this reason, the ordinary paper P1 is held in the state in which the leading edge thereof is positioned extremely close to the fixing roller 31 for a specific period of time. As the ordinary paper P1 is preheated during this period of time, the toner on the ordinary paper P1 soften and adjacent toner particles become attached to one another. This serves to prevent the occurrence of the smearing (jet mark) phenomenon. Also, even if the ordinary paper P1 becomes warped at the flexible guide plate 62, the ordinary paper P1 having a low flexure strength remains in a warped condition. Therefore, when a trailing edge of the ordinary paper P1 comes off the image transfer nipping part N1, the trailing edge does not flip abruptly so that the trailing edge of the ordinary paper P1 does not interfere with surrounding components (e.g., the top plate 112).

When the thick paper P2 passes over the flexible guide plate 62, the flexible guide plate 62 warps as the thick paper P2 having a high flexure strength presses against the flexible guide plate 62. As a result, the thick paper P2 extends almost straight toward the fixing nipping part N2 along the tangent line L drawn therefrom. Therefore, when a trailing edge of the thick paper P2 comes off the image transfer nipping part N1, the trailing edge does not interfere with the top plate 112, for example.

The rigid guide plate 61 and the flexible guide plate 62 are mounted such that the downstream end portion of the rigid guide plate 61 overlaps the upstream end portion of the flexible guide plate 62 along which the printing sheet P is transported. Thus, the leading edge of the printing sheet P transported over the upstream guide plate 50 first hits against the rigid guide plate 61 and then advances to the flexible guide plate 62, sliding along the rigid guide plate 61. It is therefore possible to prevent damage to the flexible guide plate 62 that might be caused by the leading edge of the printing sheet P hitting against the flexible guide plate 62.

Additionally, each of the rigid guide plate 61 and the flexible guide plate 62 has a width (as measured perpendicular to the sheet feeding direction) equal to or larger than a maximum width of the printing sheet P which may be transported over the rigid guide plate 61 and the flexible guide plate 62. Therefore, the printing sheet P lies on the guide member 60 all across the width of the printing sheet P so that the printing sheet P can be fed to the fixing nipping part N2 in a stable state. Furthermore, a basal part of the flexible guide plate 62 (i.e., the upstream end portion thereof) is fixed to the rigid guide plate 61 while the downstream end of the flexible guide plate 62 constitutes a free end, so that the downstream end (free end) of the flexible guide plate 62 can easily be warped by the printing sheet P depending on the type thereof.

In the second embodiment shown in FIG. 6, there is provided the slanting backplate 64 for supporting the flexible guide plate 62, and the flexible guide plate 62 is sandwiched between the rigid guide plate 61 and the slanting backplate 64. Thus, the flexible guide plate 62 can be supported in a stabler fashion compared to a case where the flexible guide plate 62 is simply adhered to the guide member 60.

The downstream end of the flexible guide plate 62 disposed against the fixing roller 31 is formed into an arcuate shape with a middle portion of the flexible guide plate 62 bulging toward the fixing roller 31 so that the downstream end of the flexible guide plate 62 fits the inverted crown shape of the fixing roller 31. This arrangement serves to prevent such inconvenience as creasing of the printing sheet P.

Furthermore, the flexible guide plate 62 has the pair of slits 621 formed therein. Thus, when the thick paper P2 having a width smaller than the distance between the two slits 621 passes over the flexible guide plate 62, only the middle portion of the flexible guide plate 62 between the two slits 621 warps. It is therefore possible to cause only the portion of the flexible guide plate 62 between the two slits 621 to warp rather than causing the flexible guide plate 62 to warp all across the width of the flexible guide plate 62.

It should be recognized that the invention is not limited to the foregoing embodiments but includes various modifications and variations thereof as described hereinbelow, for example.

(1) While the foregoing embodiments have been described with reference to the printer 10 which is an example of an image forming apparatus, the image forming apparatus of the invention need not necessarily be a printer but may be a facsimile machine, for example.

(2) While the flexible guide plate 62 is made of a film of synthetic resin in the foregoing embodiments, the flexible guide plate 62 may be a piece of a thin metal sheet. This variation allows the flexible guide plate 62 to have a greater wear resistance.

(3) While the fixing roller 31 has the inverted crown shape in the foregoing embodiments, the fixing roller 31 need not necessarily be formed into the inverted crown shape.

(4) In the foregoing embodiments, the rigid guide plate 61 and the flexible guide plate 62 are stacked such that the upstream end portion of the flexible guide plate 62 lies just beneath the downstream end portion of the rigid guide plate 61 on the bottom surface thereof. Instead of using this arrangement, the rigid guide plate 61 and the flexible guide plate 62 may be joined to each other in such a manner that the upper surface of the rigid guide plate 61 becomes flush with that of the flexible guide plate

(5) The foregoing embodiments have been described with reference to an example using the fixing roller 31 as a fixing member and the pressure roller 32 as a pressure member. This arrangement may be so modified as to employ a fixing belt as a fixing member mounted between particular rollers (one of which having a built-in electric heating element), or a pressure belt mounted between particular rollers.

While the invention has thus far been described with reference to the illustrative embodiments thereof, principal arrangements and features of the invention can be summarized as follows.

According to one feature of the invention, an image forming apparatus comprises an image transfer portion for transferring a toner image to a printing sheet, a fixing portion including a fixing member and a pressure member pressed against the fixing member for fixing the toner image to the printing sheet to which the toner image has been transferred, and a guide member disposed between the image transfer portion and the fixing portion for guiding the printing sheet carrying the toner image transferred thereto toward a nipping part formed between the fixing member and the pressure member. The guide member includes a first guide plate having rigidity, and a second guide plate having flexibility which is joined to the first guide plate at a downstream portion thereof along a sheet feeding direction, the second guide plate having a downstream end constituting a free end. The downstream end of the second guide plate is located at a position closer to the fixing member than a tangent line drawn to pass through the nipping part between the fixing member and the pressure member.

In the image forming apparatus thus configured, the second guide plate warps or does not warp depending on the level of flexure strength of the printing sheet passing over the second guide plate. This working of the second guide plate makes it possible to transport printing sheets having different flexure strengths toward the nipping part between the fixing member and the pressure member without interfering with nearby components.

Preferably, the fixing portion of the aforementioned image forming apparatus is configured to allow both an ordinary sheet of paper and a thick sheet of paper to pass through, and the flexibility of the second guide plate is such that the second guide plate does not substantially warp when the ordinary sheet of paper passes over the second guide plate but the second guide plate warps when the thick sheet of paper passes over the second guide plate.

In the image forming apparatus thus configured, an ordinary sheet of paper passing over the second guide plate (flexible guide plate) is held close to the fixing member for a while so that the ordinary sheet of paper is preheated before reaching the nipping part. As the ordinary sheet of paper is preheated in this fashion, toner on the paper softens and becomes more or less fixed thereto. This serves to prevent the occurrence of the smearing (jet mark) phenomenon. By comparison, a thick sheet of paper having a high flexure strength passing over the second guide plate (flexible guide plate) presses against the flexible guide plate, causing the flexible guide plate to warp, and as a result, the thick paper extends almost straight toward the nipping part between the fixing member and the pressure member generally along the tangent line drawn therefrom. Therefore, when a trailing edge of the thick paper comes off the image transfer portion located generally in an upstream direction of the tangent line drawn from the nipping part, the trailing edge of the thick paper does not flip abruptly so that the trailing edge does not interfere with surrounding components.

Preferably, the aforementioned image forming apparatus further comprises a supporting member for supporting the guide member, wherein the supporting member supports an upstream portion of the first guide plate from a bottom surface thereof, and the downstream portion of the first guide plate supports an upstream portion of the second guide plate on the bottom surface of the first guide plate.

In the image forming apparatus thus configured, a leading edge of the printing sheet does not hit against an upstream end of the second guide plate (flexible guide plate), making it possible to prevent damage to the flexible guide plate.

Preferably, the aforementioned image forming apparatus further comprises an upstream guide plate disposed between the image transfer portion and the guide member, wherein the upstream guide plate has a slant surface sloping downward in the sheet feeding direction, and the guide member slopes upward in the sheet feeding direction. In this configuration, the printing sheet having a low flexure strength can be transported along sloping surfaces of the upstream guide plate and the guide member so that the printing sheet can easily be slid along a top surface of the second guide plate.

The aforementioned image forming apparatus is preferably so configured that either of the first guide plate and the second guide plate has a width as measured perpendicular to the sheet feeding direction that is equal to or larger than the width of the printing sheet having a maximum width which can be handled by the image forming apparatus. In the image forming apparatus thus configured, the printing sheet lies on the guide member all across the width of the printing sheet so that the printing sheet can be fed to the nipping part of the fixing portion in a stable state.

Still preferably, the aforementioned image forming apparatus further comprises a supporting member for supporting the guide member, wherein the supporting member supports the first guide plate from a bottom surface thereof, and an upstream portion of the second guide plate is sandwiched between the supporting member and the first guide plate. In this configuration, the second guide plate can be supported in a stabler fashion compared to a case where the second guide plate is simply adhered to the first guide plate, for example.

The aforementioned image forming apparatus is preferably so configured that a middle portion of the downstream end of the second guide plate disposed against the fixing member is formed into an arcuate shape bulging toward the fixing member. In the image forming apparatus thus configured, if the fixing member is formed into an inverted crown shape, the downstream end of the second guide plate fits the inverted crown shape of the fixing member, making it possible to prevent such inconvenience as creasing of the printing sheet.

The aforementioned image forming apparatus is preferably so configured that the second guide plate has a slit formed therein to extend along the sheet feeding direction. More preferably, the image forming apparatus is so configured that at least a pair of slits is formed in the second guide plate at symmetrical positions along the width of the second guide plate in the direction perpendicular to the sheet feeding direction. In this configuration, only part of the second guide plate can be warped, so that it is possible to cause the second guide plate to warp in a surer fashion compared to a case where the second guide plate is caused to warp all across the width thereof.

The second guide plate may be made of a film of synthetic resin. The synthetic resin film is suitable as a material of the second guide plate from a viewpoint of elasticity and ease of manufacture. Alternatively, the second guide plate may be made of a thin metal sheet to make the second guide plate more wear-resistant.

In the image forming apparatus thus configured, the leading edge of the printing sheet first hits against the first guide plate after the image transfer operation and then advances to the second guide plate. It is therefore possible to prevent damage to the second guide plate that might be caused by the leading edge of the printing sheet hitting against the second guide plate.

According to another feature of the invention, an image forming apparatus configured to form an image on either of a first type of printing sheet having a first flexure strength and a second type of printing sheet having a second flexure strength comprises an image transfer portion for transferring a toner image to the printing sheet, a fixing portion including a fixing member and a pressure member pressed against the fixing member, forming a nipping part in between, for fixing the toner image to the printing sheet to which the toner image has been transferred, a sheet transporting path for guiding the printing sheet from the image transfer portion to the fixing portion, and a flexible guide plate disposed against the fixing member at a downstream position of the sheet transporting path, the flexible guide plate having a downstream end constituting a free end. The downstream end of the flexible guide plate is located at a position closer to the fixing member than a tangent line drawn to pass through the nipping part between the fixing member and the pressure member. The flexible guide plate does not substantially warp when guiding the first type of printing sheet but substantially warps when guiding the second type of printing sheet.

This application is based on Japanese Patent Application Serial No. 2008-143785, filed in Japan Patent Office on May 30, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
an image transfer portion for transferring a toner image to a printing sheet;
a fixing portion including a fixing member and a pressure member pressed against the fixing member for fixing the toner image to the printing sheet to which the toner image has been transferred; and
a guide member disposed between said image transfer portion and said fixing portion for guiding the printing sheet carrying the toner image transferred thereto toward a nipping part formed between the fixing member and the pressure member, said guide member including:
a first guide plate having rigidity; and
a second guide plate having flexibility which is joined to the first guide plate at a downstream portion thereof along a sheet feeding direction, the second guide plate having a downstream end constituting a free end;
wherein the downstream end of the second guide plate is located at a position closer to the fixing member than a tangent line drawn to pass through the nipping part between the fixing member and the pressure member.

2. The image forming apparatus according to claim 1, wherein said fixing portion is configured to allow both an ordinary sheet of paper and a thick sheet of paper to pass through, and the flexibility of the second guide plate is such that the second guide plate does not substantially warp when the ordinary sheet of paper passes over the second guide plate but the second guide plate warps when the thick sheet of paper passes over the second guide plate.

3. The image forming apparatus according to claim 1 further comprising a supporting member for supporting said guide member, wherein the supporting member supports an upstream portion of the first guide plate from a bottom surface thereof, and the downstream portion of the first guide plate supports an upstream portion of the second guide plate on the bottom surface of the first guide plate.

4. The image forming apparatus according to claim 3 further comprising an upstream guide plate disposed between said image transfer portion and said guide member, wherein said upstream guide plate has a slant surface sloping downward in the sheet feeding direction, and said guide member slopes upward in the sheet feeding direction.

5. The image forming apparatus according to claim 1, wherein either of the first guide plate and the second guide plate has a width as measured perpendicular to the sheet feeding direction that is equal to or larger than the width of the printing sheet having a maximum width which can be handled by said image forming apparatus.

6. The image forming apparatus according to claim 1 further comprising a supporting member for supporting said guide member, wherein the supporting member supports the first guide plate from a bottom surface thereof, and an upstream portion of the second guide plate is sandwiched between said supporting member and the first guide plate.

7. The image forming apparatus according to claim 1, wherein a middle portion of the downstream end of the second guide plate disposed against said fixing member is formed into an arcuate shape bulging toward said fixing member.

8. The image forming apparatus according to claim 1, wherein the second guide plate has a slit formed therein to extend along the sheet feeding direction.

9. The image forming apparatus according to claim 8, wherein at least a pair of slits is formed in the second guide plate at symmetrical positions along the width of the second guide plate in the direction perpendicular to the sheet feeding direction.

10. The image forming apparatus according to claim 1, wherein the second guide plate is made of a film of synthetic resin.

11. The image forming apparatus according to claim 1, wherein the second guide plate is made of a thin metal sheet.

12. An image forming apparatus configured to form an image on either of a first type of printing sheet having a first flexure strength and a second type of printing sheet having a second flexure strength, said image forming apparatus comprising:
an image transfer portion for transferring a toner image to the printing sheet;
a fixing portion including a fixing member and a pressure member pressed against the fixing member, forming a nipping part in between, for fixing the toner image to the printing sheet to which the toner image has been transferred;
a sheet transporting path for guiding the printing sheet from said image transfer portion to said fixing portion; and
a flexible guide plate disposed against the fixing member at a downstream position of said sheet transporting path, said flexible guide plate having a downstream end constituting a free end;
wherein the downstream end of said flexible guide plate is located at a position closer to the fixing member than a tangent line drawn to pass through the nipping part between the fixing member and the pressure member, and said flexible guide plate does not substantially warp when guiding the first type of printing sheet but substantially warps when guiding the second type of printing sheet.

13. The image forming apparatus according to claim 12, wherein said sheet transporting path is a transporting path substantially extending in a horizontal direction, said sheet transporting path having a downward-sloping slant surface on an upstream side and an upward-sloping slant surface on a downstream side.
